(19) United States
(12) Patent Application Publication
(10) Pub. No.: US 2006/0137493 A1
(43) Pub. Date: Jun. 29, 2006

(54) Ratchet wrench

(76) Inventor: Masakazu Nagata, Tokyo-to (JP)

Correspondence Address: George A Loud;Lorusso & Loud, 3137 Mount Vernon Avenue, Alexandria, VA, 22305, US

(21) Appl. No.: 10/533,525

(22) PCT Filed: Jun. 23, 2003
(86) PCT No.: PCT/JP03/07936

§ 371 Date: Mar. 3, 2006

(30) Foreign Application Priority Data
Nov. 15, 2002 (JP) 2002-332118

(51) Int. Cl. B25B 13/46

(52) U.S. Cl. 81/62

(57) ABSTRACT

Provided is a ratchet wrench for greatly decreasing the amount of wear at sliding-contact surfaces between a shank and a member which is in contact with the shank.

A shank (32) as a rotating member is brought into contact with a friction member (70) formed of a sintered copper alloy, but is kept out of contact with an annular holding portion (20b). By contact of the shank (32) with the friction member (70) formed of a sintered copper alloy, the amount of wear of a sliding-contact surface of the shank (32) with the friction member (70) and that of a sliding-contact surface of the friction member (70) with the shank (32) become extremely smaller than in the prior art. Consequently, it is possible to prevent a lowering of friction of the shank (32) and perform a tightening or loosening work for bolts, etc. stably over a long period.

### FIELD OF ART

The present invention relates to a ratchet wrench to be used for tightening or loosening bolts and nuts in an assembling or disassembling work for an automobile, an industrial machine, or the like.

### BACKGROUND ART

Electric or manual ratchet wrenches have heretofore been used for tightening or removing bolts and nuts positively and rapidly. A known ratchet wrench is shown, for example, in Patent Literature 1 or 2. A principal structure thereof will now be described with reference to FIGS. 8 to 11. Within a housing 10 is installed a crankshaft 12 (FIGS. 8 and 9) which is allowed to perform a rotational motion and a reciprocating slide motion by a motor (not shown). Integral with a front end of the crankshaft 12 is a core 14 which is eccentric and parallel to the axis of the crankshaft. A bushing 18 having an insertion hole 16 is fitted on the core 14 so as to be relatively movable with respect to the core 14.

As shown in FIG. 10, a pair of annular holding portions comprising a first annular holding portion 20a and a second annular holding portion 20b are integrally formed at a front end of the housing 10, and a swing member 22 shown in FIG. 9 is disposed between the pair of annular holding portions 20a and 20b. A hole 24 is formed centrally of the swing member 22 and an internal gear 26 is formed on an inner wall of the hole 24. The swing member 22 is provided at a front end thereof with a pair of arm portions 28, with a space 30 being formed between the pair of arm portions 28. The bushing 18 is rotatably fitted in the space 30 so as not to be disengaged from the pair of arm portion 28.

A shank 32 shown in FIG. 11 is installed into the central hole 24 of the swing member 22 mounted between the pair of annular holding portions 20a and 20b. The shank 32, which is for rotating a bolt or the like intermittently, includes a base portion 34 constituted basically by a column formed with holes and recesses and an engaging portion 36 integral with the base portion 34. A socket 37 shown in FIG. 10 is fitted on the engaging portion 36 and it is brought into engagement with a bolt or the like (not shown) to be tightened or removed. The circumferential portion of the base portion 34 as a column of the shank 32 is inserted into the central hole 24 of the swing member 22. Upon rotation of the crankshaft 12, the swing member 22 rotates about the axis of its hole 24 while being held between the pair of annular holding portions 20a and 20b.

As shown in FIG. 11, the shank 32 is provided in the interior of the base portion 34 with two blade members 40 which are swingable about shafts 38. Plural pawls 42 are formed on both right and left ends of each blade member 40. A hole 44 is formed along the axis of the columnar base portion 34 and on the side opposite to the engaging portion 36, and an arcuate groove 46 is formed along a peripheral portion of the opening of the hole 44. A columnar switching button 50 integrally formed with a knob 48 is inserted and fitted into the hole 44 (FIG. 8). In the switching button 50, as shown in FIG. 8, a pin 52 is fixed at a position close to the knob 48 and it is received within the arcuate groove 46 in the opening of the hole 44. With the pin 52, upon turning of the knob 48, the switching button 50 can rotate with respect to the shank 32 in the arcuate angle range of the groove 46. As shown in FIG. 8, pins 54 and springs 56 for urging the pins 54 are provided in the interior of the switching button 50. With the springs 56, tips of the pins 54 urge the back sides of the blade members 40 constantly. An externally projecting end side out of both right and left ends of each blade member 40 is changed by turning the knob 48, whereby the rotating direction of the shank 32 is switched from one to the other.

In the ratchet wrench shown in FIGS. 8 to 11, by operation of a motor (not shown), the crankshaft 12 performs a rotational motion and a reciprocating slide motion, the swing member 22 shown in FIG. 9 moves swingably, and the shank 32 rotates intermittently. The socket 37 shown in FIG. 10 comes into engagement with the engaging portion 36 of the shank 32 and a bolt (not shown) or the like when engaged with the socket 37 is tightened or removed.

As shown in FIG. 8, the shank 32, with an upper surface 33 (FIG. 11) of its base portion 34 in the lead, is inserted from a central space of one annular holding portion 20a toward the other annular holding portion 20b, allowing the upper surface 33 of the base portion 34 of the shank 32 to come into abutting engagement with a confronting surface 58 as a stepped portion formed inside the other annular holding portion 20b. A ring-like region surface 35 (the region between an outer edge of the upper surface and a dot-dash line) near an outer edge of the upper surface 33 of the base portion 34 of the shank 32 comes into contact with the confronting surface 58 of the annular holding portion 20b.

A washer 60, a coned disk spring 62 as a kind of spring, a guide bushing 64 and a retaining ring 66 as holding means are provided downward in this order on a back side (lower side in FIG. 8) in the inserting direction of the base portion 34 of the shank 32, and the retaining ring 66 is fixed to the annular holding portion 20a. As a result, the washer 60, the coned disk spring 62 and the guide bushing 64 are held grippingly between the shank 32 which is in abutting engagement with the annular holding portion 20b and the annular holding portion 20a which is in fixed relation to the holding means 66.

The coned disk spring 62 is used for the purpose of imparting friction to the shank 32 and for preventing the occurrence of looseness in the shank 32. The coned disk spring 62 urges the members contacting both sides of the same spring in directions away from each other, so that the shank 32 is urged upward (FIG. 8) through the washer 60 with the biasing force of the coned disk spring 62. Further, the spring force of the coned disk spring 62 urges the guide bushing 64 downward toward the retaining ring 66 fixed to the annular holding portion 20a. Consequently, the base portion 34 of the shank 32 contacts the annular holding portion 20b and the shank 32 cannot move vertically in FIG. 8. That is, the shank 32 is held without backlash between the pair of annular holding portions 20a and 20b.

With the coned disk spring 62, the ring-like region surface 35 (FIG. 11) of the upper surface 33 of the shank base portion 34 of the shank 32 is pushed against the confronting surface 58 of the annular holding portion 20b. Further, for example when tightening a bolt or the like by the shank 32, a reaction force exerted on the socket 37 (FIG. 10) acts to push the shank 32 against the annular holding portion 20b, whereby the ring-like region surface 35 at the upper surface 33 of the shank 32 is further pushed against the confronting surface 58 of the annular holding portion 20b. Thus, the force acting to push the ring-like region surface 35 at the upper surface 33 of the shank 32 against the confronting surface 58 of the annular holding portion 20b becomes larger, thus giving rise to the problem that the wear of sliding-contact surfaces (the ring-like region surface 35 at the upper surface 33 of the shank 32 and the confronting surface 58 of the annular holding portion 20b) is accelerated beyond expectations. Besides, the ring-like region surface 35 at the upper surface 33 of the shank 32 becomes worn like mirror and a friction coefficient μ of the ring-like region surface 35 of the shank 32 decreases-to a value close to zero. Thus, the decrease of friction against the shank 32 by the coned disk spring 62 due to wear of the sliding-contact surfaces and the great decrease of the friction coefficient p due to wear of the ring-like region surface 35 at the upper surface 33 of the shank 32 combine with each other, giving rise to the problem that the friction imposed on the shank 32 decreases and the bolt tightening force or the like becomes weaker.

As shown in FIG. 8, the washer 60 is held grippingly between a lower surface of the base portion 34 of the shank 32 and the coned disk spring 62, so that the opposed surfaces between the lower surface of the base portion 34 of the shank 32 and the washer 60 also become worn with a long-period use. The amount of wear of the surfaces in question is smaller than the amount of wear of opposed surfaces between the ring-like region surface 35 of the upper surface 33 of the shank 32 and the confronting surface 58 of the annular holding portion 20b, but as a result of addition of this wear of the opposed surfaces the friction (spring force) against the shank 32 by the coned disk spring 62 decreases to a greater extent.

There also is known such a conventional shank as shown in FIG. 12 wherein, instead of the retaining ring 66 for retaining the guide bushing 64, a pin 69 is installed at a position near the engaging portion 36 of the shank 32. Both ends of the pin 69 extend through the shank 32 and project outwards. The pin 69 thus projecting outside the shank 32 rotates together with the shank 32, causing wear of the guide bushing 64. As a result, the friction exerted on the shank 32 by the coned disk spring 62 further decreases, thus giving rise to the problem that bolt tightening and loosening works can no longer be performed stably.

For preventing wear of the opposed surfaces (e.g., opposed surfaces between the ring-like region surface 35 at the upper surface 33 of the shank 32 and the confronting surface 58 of the annular holding portion 20b) it may be effective to apply grease (lubricating oil) to those opposed surfaces. However, even if a user is required to apply grease to the opposed surfaces periodically, it is difficult for the user to perform the periodic application of grease; besides, such a requirement for the user should be avoided. Under the circumstances, it is desired to prevent wear of the opposed surfaces without using grease.

It is an object of the present invention to provide a ratchet wrench for greatly decreasing the amount of wear of each of sliding-contact surfaces between a shank and a member which is in contact with the shank.

### DISCLOSURE OF THE INVENTION

According to the present invention there is provided a ratchet wrench comprising a housing having a first annular holding portion and a second annular holding portion spaced from each other, a shank having a base portion and an engaging portion and disposed between the first and second annular holding portions, and a spring for imparting friction to the shank and for urging the shank toward the second annular holding portion, wherein a friction member formed of a sintered copper alloy is interposed between the base portion of the shank and the second annular holding portion. The sintered copper alloy may be dotted with a refractory metal or may be dotted with a ceramic or synthetic resin material within porous voids. In case of a washer being disposed between the shank and the spring, the washer is formed of a sintered copper alloy. In case of a pin being fixed near the engaging portion of the shank and a guide bushing disposed between the pin and the spring, the guide bushing is formed of a sintered copper alloy.

According to the present invention there also is provided a ratchet wrench comprising a housing having a first annular holding portion and a second annular holding portion spaced from each other, a shank having a base portion and an engaging portion and disposed between the first and second annular holding portions, and a spring for imparting friction to the shank and for urging the shank toward the second annular holding portion, wherein a film made of a sintered copper alloy is formed on at least one of a contact surface of the shank with the second annular holding portion or a contact surface of the second annular holding portion with the shank. The sintered copper alloy may be dotted with a refractory metal or may be dotted with a ceramic or synthetic resin material within porous voids. In case of a washer being disposed between the shank and the spring, the washer is formed of a sintered copper alloy. In case of a pin being fixed near the engaging portion of the shank and a guide bushing disposed between the pin and the spring, the guide bushing is formed of a sintered copper alloy.

### BRIEF DESCRIPTION OF THE DRAWINGS

FIG. 1 is a sectional view showing a principal portion of a ratchet wrench according to an embodiment of the present invention,

FIG. 2 is an enlarged sectional view of a principal portion shown in FIG. 1,

FIG. 3 is a perspective view of a friction member and a shank both used in the present invention,

FIG. 4 is a table showing the amount of wear of a friction member formed of a known material and that of a friction member formed of a material according to the present invention,

FIG. 5 is a sectional view of a principal portion of a ratchet wrench according to another embodiment of the present invention,

FIG. 6 is a perspective view of a friction member and a shank both used in FIG. 5,

FIG. 7 is a sectional view showing a principal portion of a ratchet wrench according to a further embodiment of the present invention,

FIG. 8 is a sectional view of a principal portion of a conventional ratchet wrench,

FIG. 9 is a perspective view showing a conventional swing member,

FIG. 10 is a perspective view of the conventional ratchet wrench with a socket attached thereto,

FIG. 11 is a perspective view showing a conventional shank, and

FIG. 12 is a sectional view of a principal portion of another conventional shank.

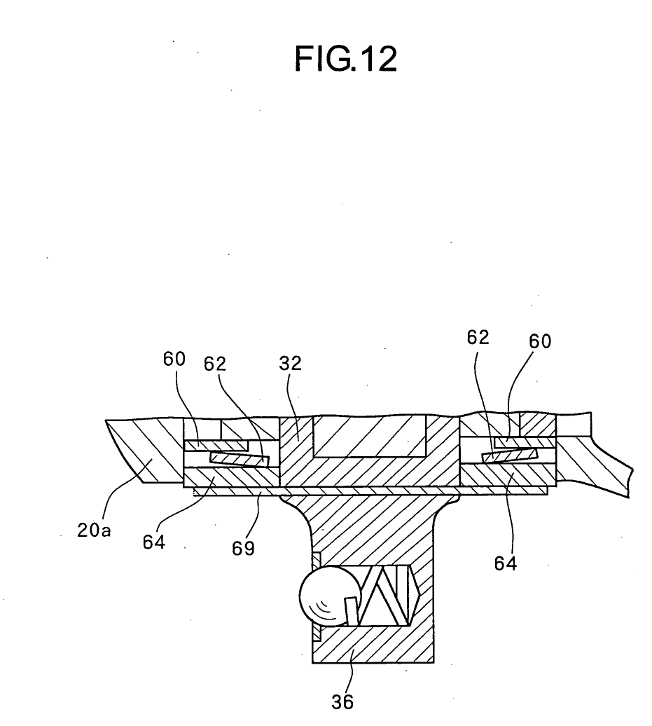

### FIRST BEST MODE FOR CARRYING OUT THE INVENTION

Next, the present invention will be described below with reference to the drawings.

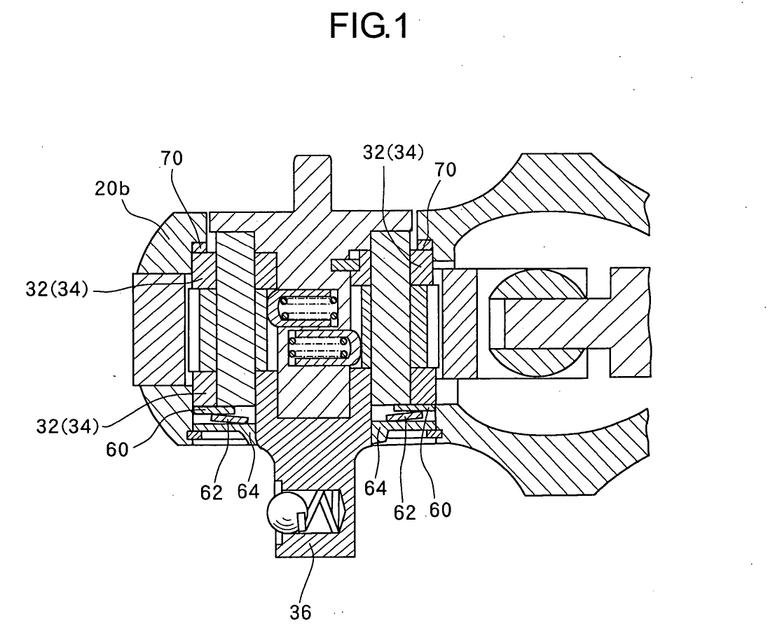

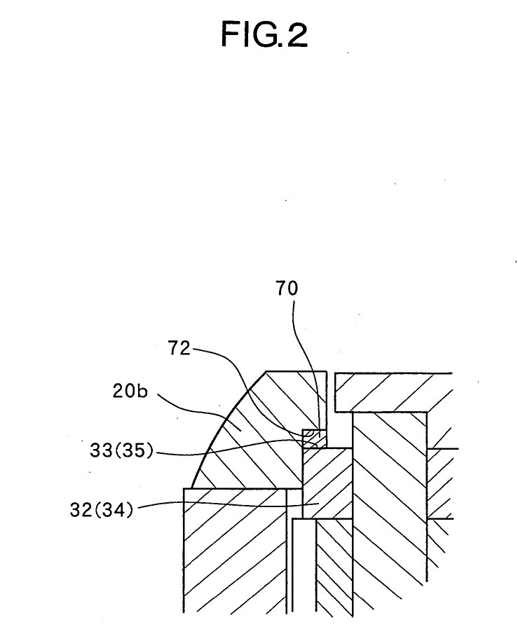

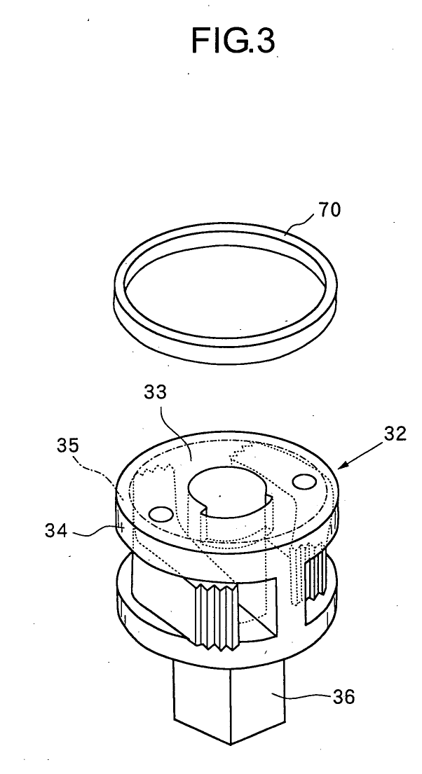

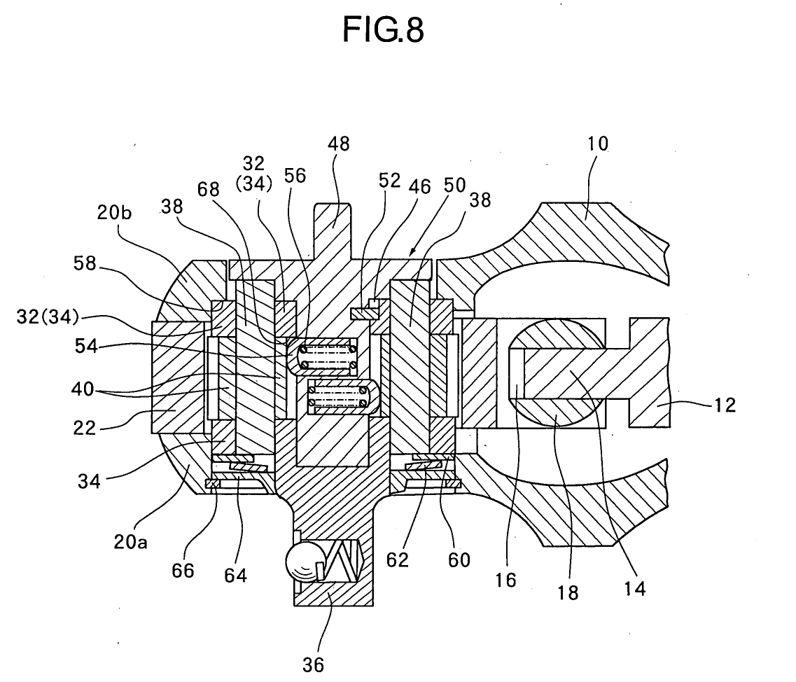

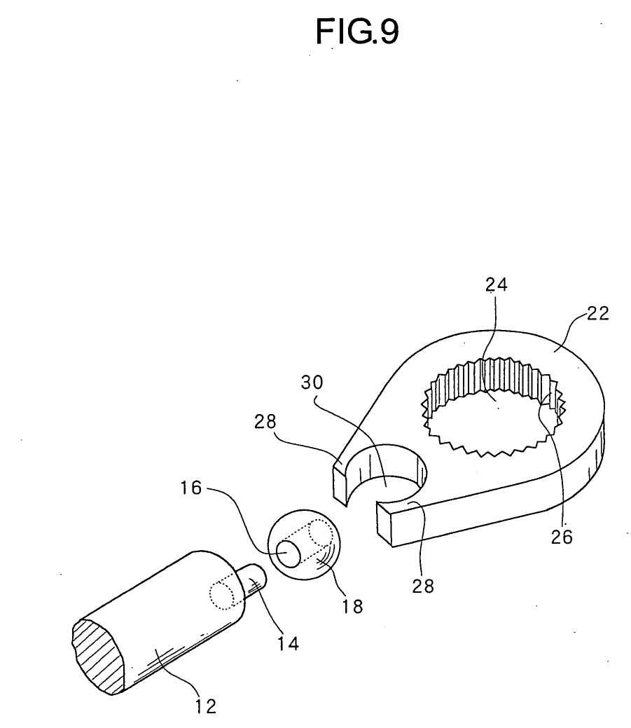

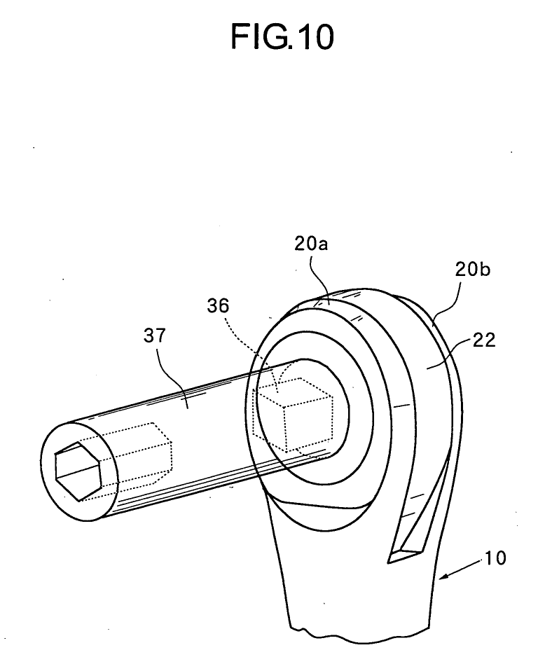

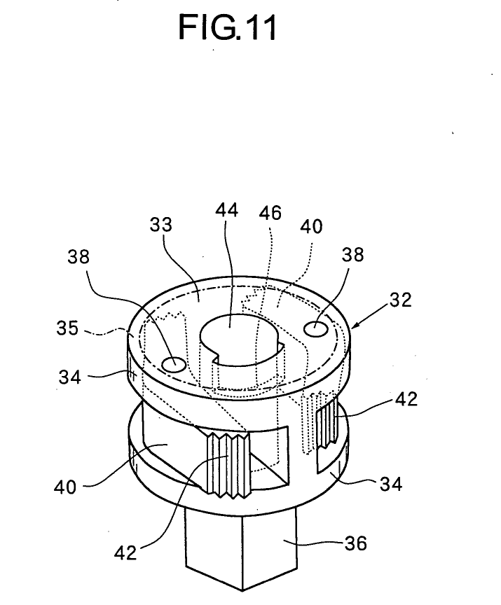

FIG. 1 is a sectional view of a principal portion of a ratchet wrench according to the present invention, FIG. 2 is an enlarged sectional view of a principal portion shown in FIG. 1, and FIG. 3 is a perspective view of a friction member and a shank both used in the present invention. In FIGS. 1 to 3, the same reference numerals as in FIGS. 8 to 11 denote the same members as in those figures. In the ratchet wrench according to the present invention, a friction member 70 shown in FIGS. 1 to 3 is newly added in comparison with the conventional ratchet wrench. In this first embodiment, the same shank 32 as the conventional one shown in FIG. 8 is used. In the annular holding portion 20b shown in FIGS. 1 and 2, a confronting surface 72 (FIG. 2) as a stepped portion is formed at a position opposed to the region surface 35 of the shank 32. As compared with the confronting surface 58 of the annular holding portion 20b shown in FIG. 8, the confronting surface 72 is formed at a position (recess 71) which is hollowed by an amount corresponding to the thickness of the friction member 70. The friction member 70, which is formed in an annular shape, is fitted in the recess 71. That is, the friction member 70 is interposed between the region surface 35 of the shank 32 and the confronting surface 72 of the annular holding portion 20b. Although the friction member 70 is formed in an annular shape, its shape is not limited to the annular shape. As shown in FIGS. 1 and 2, by installing the friction member 70 in between the upper surface 33 (region surface 35) of the shank 32 and the confronting surface 72 of the annular holding member 20b, the upper surface 33 of the shank 32 is put out of contact with the annular holding portion 20b although the upper surface 33 of the shank 32 is in contact with the friction member 70. Lubrication oil is not used for the contact surfaces between the upper surface 33 of the shank 32 and the friction member 70.

A sintered copper alloy is used as the material of the friction member 70 used in the present invention. In the case where the surface pressure applied to the friction member 70 is high, there is used a sintered copper alloy dotted with a refractory metal. In the case where the surface pressure applied to the friction member 70 is a medium-level pressure, there is used a sintered copper alloy with a ceramic or synthetic resin material dotted in porous voids. The friction member 70 formed of a sintered copper alloy as the material means a friction member at least the surface of which is formed of the sintered copper alloy. That is, a friction member having a surface coated with a sintered copper alloy is also included.

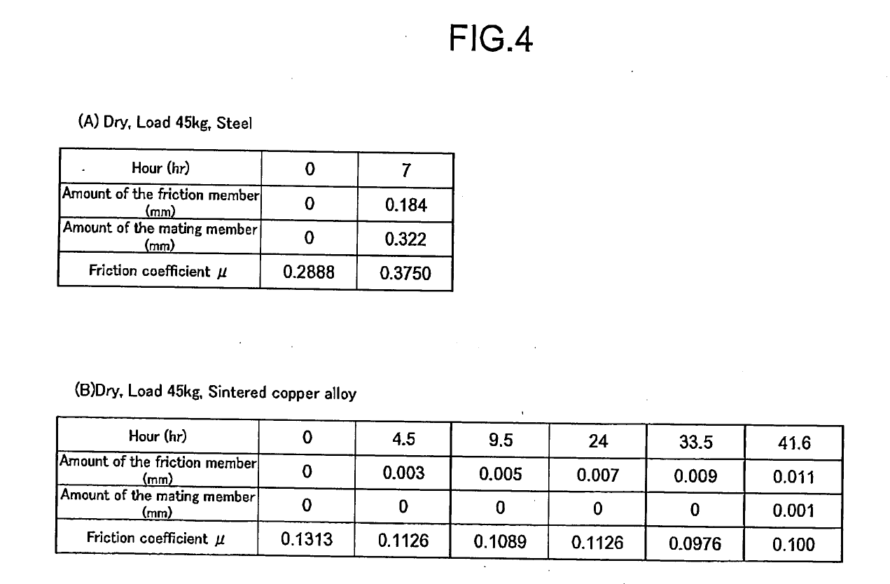

FIG. 4 is a table showing the amount of wear of a friction member 70 (the surface of sliding contact with the shank 32) using steel as the material thereof, that of a friction member 70 (the surface of sliding contact with the shank 32) using a sintered copper alloy as the material, and that of the shank 32 (the surface of sliding contact with the friction members 70) in use for long hours. The amount of wear of the friction member 70 using steel is shown in FIG. 4(A) and that of the friction member using a sintered copper alloy is shown in FIG. 4(B). In both FIGS. 4(A) and 4(B), the amount of wear and friction coefficient p are on a dry basis (a state not using lubrication oil). In FIG. 4(A), in 7-hour use, the amount of wear of the friction member 70 made of steel became 0.184 mm, that of the region surface 35 of the shank 32 as the mating member became 0.322 mm, and the total amount of wear of the two became 0.506 mm. Particularly, the amount of wear (0.322 mm) of the region surface 35 of the shank 32 was larger than that of the friction member 70 made of steel. When the amount of wear becomes about 0.2 to 0.3 mm, the pressing force of the coned disk spring 62 against the shank 32 becomes extremely weak, so in the case where the friction member 70 made of a known material (steel) is brought into contact with the shank 32, it is impossible to remedy the conventional drawback. Further, in 0- and 7-hour use, as shown in FIG. 4(A), the friction coefficient p becomes very large, resulting in that the wear of both sliding-contact surfaces is accelerated. However, though not shown in FIG. 4(A), in use for a sufficiently longer time, the surface of contact of the shank 32 with the friction member 70 becomes mirror-like and the value of friction coefficient μ is close of zero, so that the friction against the shank 32 becomes lower and it is no longer possible to perform a tightening or loosening work for bolts, etc.

As shown in FIG. 4(B), in 41.6-hour use of the friction member 70 made of a sintered copper alloy as the material, the amount of wear of the friction member 70 was 0.011 mm, that of the region surface 35 of the shank 32 as the mating member was 0.001 mm, and the total amount of wear of the two was 0.012 mm. It is seen that the amount of wear of sliding-contact surfaces is smaller during rotation (except 0 hour) than in stationary mutual contact (0 hour) because the friction coefficient μ is the smaller during rotation. Further, even in long-period use, the friction coefficient p show almost equal stable values. From the results shown in FIG. 4(B) it is seen that, by contacting the friction member 70 made of a sintered copper alloy with the shank 32, the amount of wear of the sliding-contact surface of the shank 32 against the friction member 70 decreases to a great extent in comparison with the conventional example. Thus, it is possible to prevent a lowering of friction exerted on the shank 32 by the spring and perform a tightening or loosening work for bolts, etc. stably.

Second Best Mode for Carrying Out the Invention

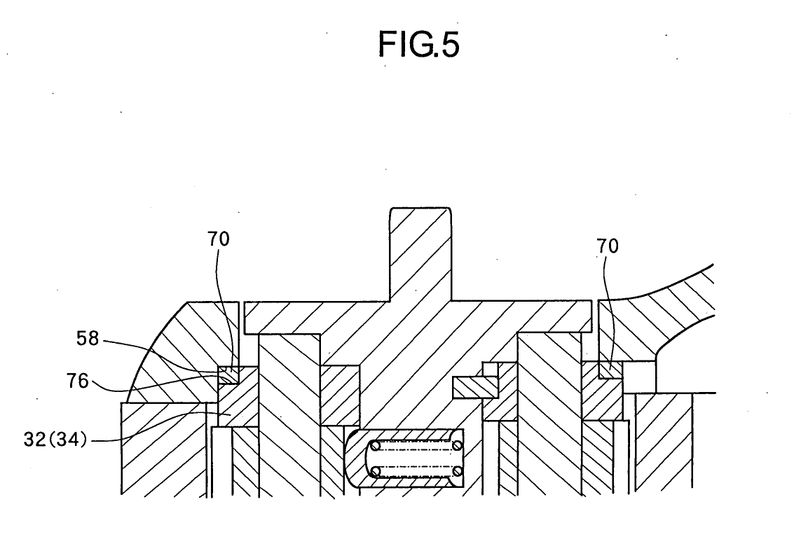

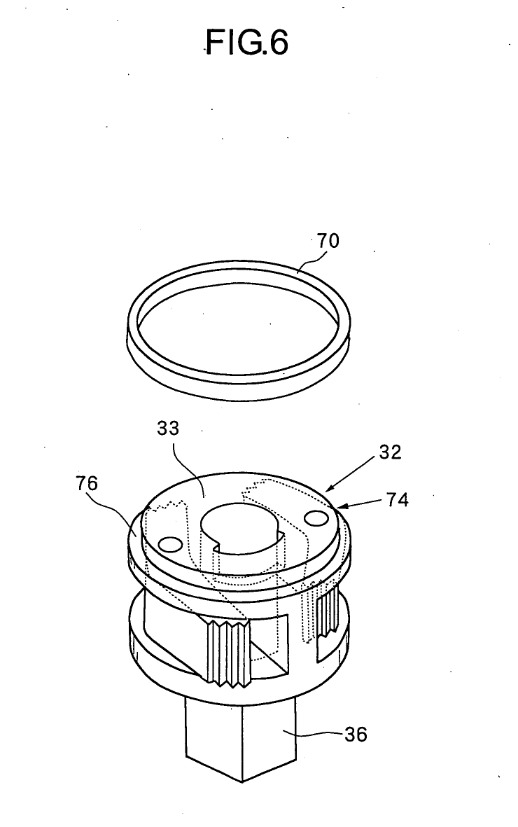

Another embodiment of the present invention will be described below with reference to FIGS. 5 and 6.

In FIGS. 5 and 6, the same reference numerals as in FIGS. 1 to 3 denote the same members as in those figures. Also in this second embodiment there is used a friction member 70 made of the same sintered copper alloy as in the first embodiment as the material. A shank 32 used in this second embodiment is different in shape from the shank 32 shown in FIG. 3. In the shank 32 used in this second embodiment, an annular cutout portion 74 is formed in the outer periphery of an upper surface 33 so that the depth thereof corresponds substantially to the thickness of the friction member 70 which is in a ring shape. A region surface 76 as an annular stepped portion is formed by the cutout portion 74. The shape of the region surface 76 is almost the same as the shape of the region surface 35 of the shank 32. The friction member 70 is fitted in the cutout portion 74 of the shank 32. An annular holding portion 20b used in this second embodiment is the same as that shown in FIG. 8 and has an opposite surface 58 as a stepped portion.

As shown in FIG. 5, when the friction member 70 is sandwiched in between the annular holding portion 20b and the shank 32, one of both sides of the friction member 70 is put in contact with the region surface 76 of the shank 32, while the other comes into contact with the confronting surface 58 of the annular holding portion 20b. That is, also in this second embodiment, as in the first embodiment, the shank 32 (region surface 76) comes into contact with the friction member 70, but does not contact the annular holding portion 20b. As a result, also in this second embodiment, the amount of wear of the region surface 76 of the shank 32 which is in contact with the friction member 70 and the amount of wear of the friction member 70 which is in contact with the region surface 76 of the shank 32 become equal to those shown in the table of FIG. 4(B) and thus the amount of wear of the shank 32 can be greatly decreased. Therefore, it is possible to prevent a lowering of friction exerted on the shank 32 by the spring and perform a tightening or loosening work for bolts, etc. stably.

Third Best Mode for Carrying Out the Invention

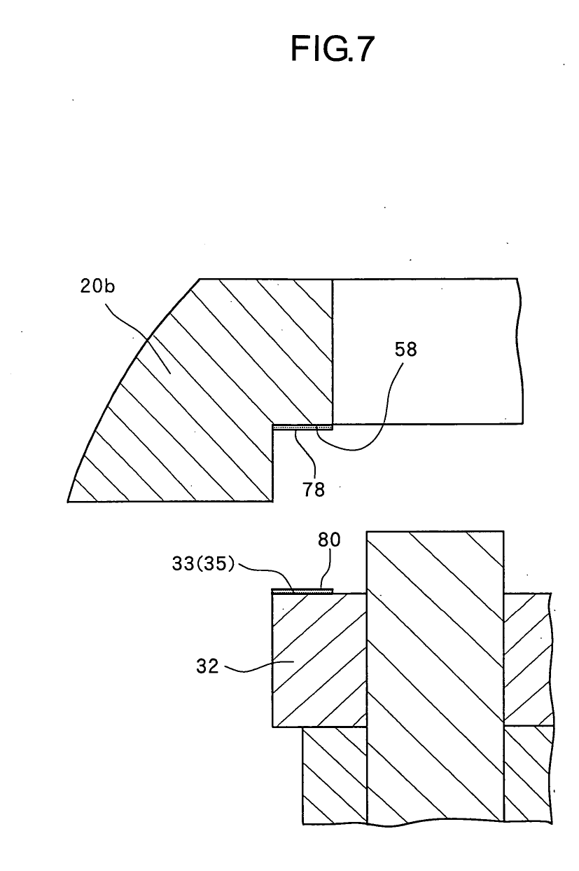

Next, a further embodiment of the present invention will be described with reference to FIG. 7. In this third embodiment the friction member 70 used in the first and second embodiments is not used. Moreover, in this third embodiment the shank 32 and the annular holding portion 20b shown in FIG. 8 which relates to a conventional example are used as they are. In the annular holding portion 20b, a film 78 of a sintered copper alloy is formed on the confronting surface 58. In the shank 32, a film 80 of a sintered copper alloy is formed on the region surface 35 at the upper surface 33 opposed to the confronting surface 58 of the annular holding portion 20b. In this third embodiment, the film 78 or 80 of a sintered copper alloy is formed on at least one of the confront surface 58 of the annular holding portion 20b or the region surface 35 of the shank 32. The sintered copper alloy may be dotted with a refractory metal or dotted with a ceramic or synthetic resin material in porous voids. Also in this third embodiment, the amount of wear of sliding-contact surfaces (between the film 80 or 78 and the region surface 35 of the shank 32) becomes equal to the one shown in FIG. 4(B) and thus the amount of wear of the shank 32 can be greatly decreased.

Fourth Best Mode for Carrying Out the Invention

As shown in FIG. 1, a washer 60 is held grippingly by both the lower surface of the base portion 34 of the shank 32 and the coned disk spring 62. In this embodiment the washer 60 is formed of a sintered copper alloy. The washer 60 may be one whose surface is coated with the sintered copper alloy. The sintered copper alloy may be one dotted with a refractory metal or may be one dotted with a ceramic or synthetic resin material in porous voids. By thus forming the washer 60 with use of the sintered copper alloy, as shown in FIG. 4(B), the amount of wear of the lower surface of the base portion 34 of the shank 32 at the surface of contact with the washer 60 can be decreased. Consequently, it is possible to prevent a lowering of friction exerted on the shank 32 by the spring and perform a tightening or loosening work of bolts, etc. stably.

Fifth Best Mode for Carrying Out the Invention

As shown in FIG. 1, a guide bushing 64 is held grippingly by both coned disk spring 62 and retaining ring 66. In this embodiment, the guide bushing 64 is formed of a sintered copper alloy. The guide bushing 64 may be one whose surface is coated with the sintered copper alloy. The sintered copper alloy may be one dotted with a refractory metal or one dotted with a ceramic or synthetic resin material in porous voids. By thus forming the guide bushing 64 out of the sintered copper alloy, the amount of wear of the guide bushing 64 which is in contact with the coned disk spring 62 and the retaining ring 66 can be decreased and hence it is possible to prevent a lowering of friction exerted on the shank 32.

### INDUSTRIAL APPLICABILITY

According to the ratchet wrench of the present invention, as described above, the amount of wear of the shank and that of the member in sliding contact with the shank can be greatly decreased by using a sintered copper alloy as the material of the member coming into contact with the shank which is rotating, so that it is possible to prevent a lowering of friction exerted on the shank and perform a tightening or loosening work for bolts, etc. stably over a long period.

1. A ratchet wrench comprising a housing having a first annular holding portion and a second annular holding portion spaced from each other, a shank having a base portion and an engaging portion and disposed between said first and second annular holding portions, and a spring for imparting friction to said shank and for urging the shank toward said second annular holding portion, wherein a friction member formed of a sintered copper alloy is interposed between said base portion of said shank and said second annular holding portion.

2. A ratchet wrench according to claim 1, wherein a washer is disposed between said shank and said spring, said washer being formed of a sintered copper alloy.

3. A ratchet wrench according to claim 1, wherein a pin is fixed near said engaging portion of said shank and a guide bushing is disposed between said pin and said spring, said guide bushing being formed of a sintered copper alloy.

4. A ratchet wrench according to claim 1, wherein said sintered copper alloy is dotted with a refractory metal.

5. A ratchet wrench according to claim 1 wherein said sintered copper alloy is dotted with a ceramic material in porous voids.

6. A ratchet wrench according to claim 1, wherein said sintered copper alloy is dotted with a synthetic resin material in porous voids.

7. A ratchet wrench comprising a housing having a first annular holding portion and a second annular holding portion spaced from each other, a shank having a base portion and an engaging portion and disposed between said first and second annular holding portions, and a spring for imparting friction to said shank and for urging the shank toward said second annular holding portion, wherein a film of a sintered copper alloy is formed on at least one of a surface of contact of said shank with said second annular holding portion or a surface of contact of said second annular holding portion with said shank.

8. A ratchet wrench according to claim 7, wherein a washer is disposed between said shank and said spring, said washer being formed of a sintered copper alloy.

9. A ratchet wrench according to claim 7, wherein a pin is fixed near said engaging portion of said shank and a guide bushing is disposed between said pin and said spring, said guide bushing being formed of a sintered copper alloy.

10. A ratchet wrench according to claim 7, wherein said sintered copper alloy is dotted with a refractory metal.

11. A ratchet wrench according to claim 7, wherein said sintered copper alloy is dotted with a ceramic material in porous voids.

12. A ratchet wrench according to claim 7, wherein said sintered copper alloy is dotted with a synthetic resin material in porous voids.
